(19) United States
(12) Patent Application Publication
(10) Pub. No.: US 2026/0201238 A1
(43) Pub. Date: Jul. 16, 2026

(54) DRILLING FLUIDS

(71) Applicant: LAMBERTI SPA, Albizzate (IT)

(72) Inventors: Luigi MERLI, Saronno (IT); Laura VIGANÒ, Parabiago (IT); Lycia BERTANI, Boffalora Sopra Ticino (IT)

(73) Assignee: LAMBERTI SPA, Albizzate, VA (IT)

(21) Appl. No.: 19/137,585

(22) PCT Filed: Dec. 11, 2023
(86) PCT No.: PCT/EP2023/085043

§ 371 Date: Jun. 10, 2025

(30) Foreign Application Priority Data
Dec. 15, 2022 (IT) 102022000025743

(51) Int. Cl. C09K 8/28; E21B 21/00

(52) U.S. Cl. CPC C09K 8/28; E21B 21/003

(57) ABSTRACT

Methods of reducing the soil disintegration while drilling a wellbore for oil or gas production through unstable clayey soils. The method comprises drilling the well in the presence of a water-based drilling fluid that includes natural wax microparticles that improve the stability of the wellbore by significantly reducing the interactions of the drilling fluid with such soils.

### FIELD OF THE INVENTION

The present invention relates to a method of reducing the soil disintegration when drilling a wellbore for the production of oil or gas through unstable clayey soils. The method comprises drilling the well in the presence of a water-based drilling fluid that comprises natural wax microparticles that improves the stability of the wellbore by sensibly reducing the interactions of the drilling fluid with such soils.

### PRIOR ART

Drilling fluids, which are also called drilling muds, are complex mixtures of chemicals used in drilling operations of wellbore for the production of hydrocarbons and natural gas from subterranean reservoirs.

Drilling fluids can be classified according to the nature of their continuous phase. There are oil-based drilling fluids (OBM), in which solids are suspended in a continuous oleaginous phase. Often, OBM contain water or brine emulsified into the oleaginous phase.

Alternatively, water-based drilling fluids (WBM) contain solids suspended in water or brine.

Drilling fluids are pumped inside the drilling shaft and exit from the drilling bit through small openings. The drilling fluids return to the surface through the annulus between the outside of the drilling shaft and the borehole wall.

Drilling fluids, through the several additives they contain, perform a number of functions.

Exemplary of these functions are: cooling and lubricating the drill bit, creating hydrostatic pressure to avoid uncontrolled blow outs and to help supporting the weight of the borehole walls, carrying drill cuttings up to the surface and suspending them when the fluid circulation is stopped.

Drilling fluids, moreover, create on the bore hole walls and eventually on the surface of porous geological formations a filter cake having low permeability. The liquid permeating the filter cake and the formation is called “filtrate”.

WBM are attractive alternatives to OBM, both from the cost and the environmental perspectives. Disadvantageously, however, clay-rich rocks, such as shales, tend to hydrate when in contact with water-based drilling fluids. Clay hydration, results in two distinctly different problems, one being swelling, which is expansion of the clays due to water uptake, and the other being dispersion, which is the disintegration (disaggregation) of the clay body due to water contact. During drilling, shales are susceptible to a variety of problems ranging from washout to complete hole collapse.

In order to reduce the problems related to clay instability when using water-based drilling fluids, many additives have been described, including shale inhibitors, such as polyalkoxy diamines, oligomethylene diamines and polyamine and their salts, quaternary ammonium compounds, which inhibit the swelling of the clays, and wellbore stabilizers, such as synthetic polymers, e.g. styrene-butadiene latexes, which create a protective film on the surface of the clays.

However, there is still the need of an additive with improved wellbore stabilizing performances and, possibly, further advantageous activities.

It has now been found that microparticles of a natural wax having a melting point comprised between 3° and 95° C., significantly inhibit the interactions of water-based drilling fluid with unstable clayey soils, thus stabilizing the wellbore.

These wax microparticles also act as fluid loss reducers and drilling bit lubricants and, in addition, they are sustainable and biodegradable.

As far as the applicant knows, the improvement of the wellbore stabilization induced by microparticles of a natural wax having a melting point comprised between 3° and 95° C. is not known in the art.

In the present text, the term “unstable clayey soil” means soil containing not only swellable but also dispersive clays: such soils are susceptible to erosion. Dispersive clays are characterized by a marked tendency to disaggregate in presence of water and to detach from the wellbore walls. Typically, dispersive clays contain high percentages of exchangeable sodium cations.

Dispersive clays in the wellbore soil can be identified and their dispersivity quantified using various different methods, some of which are standardized methods. Here we mention the “Double Hydrometer Test” (Test method ASTM D4221-18), the “Pinhole Dispersion Test” (Test method ASTM D4647/D4647M), the “Crumb Test” (Test method ASTM D6572) and the “Pore Water Extraction Test” (Test method ASTM D4542).

According to the present disclosure, the test methods may be performed individually or used together to verify the dispersivity of the unstable clayey soil.

In the present invention, the median particle size is calculated from volume-based distributions (Dᵥ50), determined by Dynamic Light Scattering.

### DESCRIPTION OF THE INVENTION

The present disclosure relates to a method of reducing the soil disintegration when drilling a wellbore for the production of oil or gas in unstable clayey soils.

The method comprises the following steps: (a) providing a water-based drilling fluid comprising from 0.5 to 6.0 g/100 ml of a microparticles having a median particle size comprised between 0.020 and 10 □m of a natural wax with a melting point comprised between 3° and 95° C.; (b) drilling the borehole in the presence of the water-based drilling fluid that contains said wax microparticles, thereby reducing the clayey soil disintegration.

The present disclosure further relates to the use of from 0.5 to 6.0 g/100 ml of said natural wax microparticles, in a water-based drilling fluid, for reducing the soil disintegration when drilling a wellbore for the production of oil or gas in unstable clayey soils.

### DETAILED DESCRIPTION OF THE INVENTION

According to a preferred aspect, the water-based drilling fluid of the method and use of the invention comprises from 1.0 to 5.0 g/100 ml of said natural wax microparticles.

Preferably, the median particle size of the natural wax microparticles of the invention is comprised between 0.040 and 7 m, more preferably between 0.040 and 1.0 m, most preferably between 0.040 and 0.25 m.

Preferably, the natural waxes of the invention have a melting point comprised between 35 and 90° C.

Examples of natural waxes, suitable for the realization of the present invention, include, but are not limited to, Carnauba Wax, Candelilla Wax, Beeswax, Rice bran Wax, Sumac Wax, Jojoba Wax and mixtures thereof.

Carnauba Wax, also called Brazil wax and palm wax, is a wax extracted from the leaves of the carnauba palm Copernicia prunifera, a plant grown only in the northeastern Brazilian states. Carnauba wax consists mostly of aliphatic esters (40 wt %), diesters of 4-hydroxycinnamic acid (21.0 wt %), ω-hydroxycarboxylic acids (13.0 wt %), and fatty alcohols (12 wt %). The compounds are predominantly derived from acids and alcohols in the C₂₆-C₃₀ range.

Candelilla Wax is a wax derived from the leaves of the small Candelilla shrub native to northern Mexico and the southwestern United States, Euphorbia antisyphilitica, from the family Euphorbiaceae. Candelilla wax consists of mainly C₂₉-C₃₃ hydrocarbons (about 50%), esters of higher molecular weight (20-29%), free acids (7-9%), and resins (12-14%, mainly triterpenoid esters).

Beeswax is the substance that forms the structure of a honeycomb. The beeswax composition is: C₂₇-C₃₃ hydrocarbons (12%-16%), mainly heptacosane, nonacosane, hentriacontane, pentacosane and tricosane; C₂₄-C₃₂ free fatty acids (12%-14%); C₂₈-C₃₅ free fatty alcohols (ca. 1%); C₄₀-C₄₈ linear wax monoesters and hydroxymonoesters (35%-45%) generally derived from palmitic, 15-hydroxypalmitic and oleic acids; complex wax esters (15%-27%) containing 15-hydroxypalmitic acid or diols, which through their hydroxyl group, are linked to another fatty-acid molecule.

Rice bran Wax is the vegetable wax extracted from the bran oil of rice, Oryza sativa. It is a hard, crystalline, consisting of very long chain saturated C₄₆-C₆₂ esters from C₂₀-C₃₆ fatty alcohols and C₂₀-C₂₆ fatty acids.

Sumac Wax is derived from berry fruits of Rhus succedanea tree, referred to as the Chinese (or Japanese) Sumac tree. Sumac wax is rich in high content of C₁₆-C₁₈ fatty acid triglycerides.

Jojoba wax is obtained from the seeds of Simmondsia chinensis plants and is composed mainly of esters and, to a lesser extent, free acids, free alcohols, and hydrocarbons. Esters are obtained by the reaction of long straight-chain fatty acids with long straight-chain or higher molecular weight monohydric alcohols, both containing a cis-monounsaturation at the (ω-9) position. Examples of these esters are eicosenyl eicosenoate, eicosenyl docosenoate, docosenyl docosenoate and the like. Small triglyceride esters are also present.

It has been found that all the above-mentioned natural waxes can prevent the disintegration of the unstable clayey soils. Carnauba wax is the preferred wax as it shows also a remarkable properties of fluid loss reduction and has no significant impact on fluid rheology.

The natural wax microparticles of the invention can be conveniently added to the water-based drilling fluid in the form of solid microparticles or in the form of an emulsion (dispersion). The natural wax microparticles are preferably added to the water-based drilling fluid in the form of an emulsion, more preferably in the form of an aqueous emulsion.

Aqueous emulsions of natural wax are generally known.

Aqueous natural wax emulsions are primarily composed of wax particles, dispersants/surfactants, and water. The dispersants can be non-ionic, anionic, and cationic, and can also be polymeric or combinations thereof. Wax particles can be formed by various methods known in the art. For example, they can be prepared by pulverizing and classifying dry waxes or by spray drying of a solution containing waxes followed by redispersing the resultant particles in in water using a dispersant. They can be prepared by a suspension technique which consists of dissolving a wax in, for example, a water immiscible solvent, dispersing the solution as fine liquid droplets in aqueous solution, and removing the solvent by evaporation or other suitable techniques. They can be prepared by mechanically grinding a wax material in water to a desired particle size in the presence of a dispersant, heating the wax particles dispersed in water to above their melting point, and cooling the melted particles in water to form a stable emulsion.

In the present invention, the natural wax emulsions are preferably prepared by the so-called “atmospheric emulsification”. Atmospheric process is used to prepare wax dispersions for waxes with melting points below the boiling point of water. The process typically consists of melting wax and surfactant together. Hot water is then slowly added to the wax melt under vigorous stirring (water to wax). The natural wax emulsion of the invention can also be prepared by adding the molten wax/surfactant blend to boiling water under vigorous stirring.

The natural wax microparticles of the invention are preferably added to the water-based drilling fluid in the form of aqueous emulsions, because emulsification easily provides wax microparticles with a small size. Microparticle sizes in the emulsions vary in the range of about 0.01 μm up to about 10 μm, more typically in the range of from 0.01 to 1 μm. Usually, the median particle size in the aqueous natural wax emulsions of the invention is between 0.030 and 0.50 μm, preferably between 0.03 and 0.25 μm.

Usually, the natural wax emulsion of the invention comprises from 10 to 45% by weight, preferably from 15 to 35 by weight, of wax.

In the method and use of the invention, aqueous wax emulsions are also preferred because they are stable, easily manageable and readily dispersible in the drilling fluid.

In a preferred embodiment, the method of reducing the soil disintegration, when drilling a wellbore for the production of oil or gas in unstable clayey soils, comprises the following steps: (a) providing a water-based drilling fluid comprising from 0.5 to 6.0 g/100 ml of microparticles with a median particle size below 10 □m of a natural wax having a melting point below 95° C., wherein said natural wax microparticles are added in the form of an aqueous emulsion that comprises from 10 to 45 by weight of wax microparticles; (b) drilling the borehole in the presence of the water-based drilling fluid that contains the natural wax microparticles, thereby reducing the soil disintegration.

Without being bound to any theory, it is believed that the natural wax microparticles of the invention, by adhering on the wellbore surface, create a sort of a hydrophobic barrier, reducing fluid loss and the interactions between the fluid and the soil, therefore inhibiting the dispersions of the clays.

The water-based drilling fluid of the present invention comprises the usual ingredients commonly used in the field.

The water-based drilling fluid of the present invention may be formulated with brines.

Useful salts for the preparation of brines include, but are not limited to, sodium, calcium, aluminum, magnesium, strontium, potassium and lithium salts of chlorides, carbonates, bromides, iodides, chlorates, bromates, nitrates, formates, phosphates, sulfates.

The brine may also comprise seawater.

The density of the water-based drilling fluid is generally regulated by increasing the salt concentration of the brine and/or by the addition of specific weighting agents. Suitable weighting agents are barite, siderite, galena, dolomite, ilmenite, hematite, iron oxides, calcium carbonates and the like.

In the method and use of the invention, the aqueous drilling fluid comprises further additives commonly used in the field.

Advantageously, the water-based drilling fluid of the invention contains fluid loss reducers such as cellulose derivatives (preferably polyanionic cellulose) and/or starch and/or starch derivatives.

The water-based drilling fluid of the invention may also contain a lubricant. Examples of suitable lubricants may include, but are not limited to vegetable oils, olefins, phosphates, esters, glycols, fatty esters, alkanol amines fatty esters, or any combination thereof.

The water-based drilling fluids usually contain rheology modifiers. Suitable rheology modifiers are gelling agents and viscosifiers, such as natural polymers or derivatives thereof, biopolymers, high molecular weight synthetic polymers, and the like.

The water-based drilling fluids of the invention may also contain a shale inhibitor. Examples of suitable shale inhibitors are potassium salts, polyalkoxy diamines, choline derivatives, oligomethylene diamines and polyamine and their salts, quaternary ammonium compounds, cationic polymers and the like.

Other conventional additives that may be contained in the water-based drilling fluid are encapsulating agents and dispersants, such as lignosulfonates, tannins, polyacrylates and the like.

Examples are reported here below to illustrate the invention.

### Examples

### Dispersive Clay Disintegration Test

The test was performed following the procedure described in the standard method ISO10416, section 22, with some modifications. To perform this test were used dispersive clay particles with a size between 2 and 4 mm previously desiccated at room temperature to constant moisture.

350 ml of exemplary water-based drilling fluid were prepared by means of a Hamilton Beach Mixer according to the formulations described in Table 1. All fluids were adjusted to pH about 9 by adding some drops of a 20 wt % NaOH solution.

The natural wax microparticles were added to the water-based drilling fluid in the form of an aqueous emulsion. The emulsions contained about 25 wt % of natural wax and a nonionic surfactant and were prepared by atmospheric emulsification. The analysis of the particle size distribution, measured using a Malvern Zetasizer NANO ZS90, evidenced a median size of the microparticles comprised between about 0.050 and 0.15 μm, based on the volume of the particles. The melting point in ° C. of the natural waxes utilized for the Examples, determined by DSC, is reported in Table 2.

The behaviour of the fluids containing the emulsions of the natural waxes were compared with that of a blank (without any wax) and that of a fluid containing an emulsion of Polyethylene Wax (Adiwax H05B, from Lamberti S.p.A.)

TABLE 1

| Ingredients | Blank | Examples |
|---|---|---|
| Tap Water | 330 | 330 |
| KCl | 10.5 | 10.5 |
| Xanthan gum | 1 | 1 |
| Starch | 5 | 5 |
| Encapsulating Agent | 2 | 2 |
| Wax Emulsion | — | 17.5 |
| CaCO₃ | 30 | 30 |

30 g of clay were added to each fluid in a stainless steel test cell which was subsequently closed and vigorously shacked to disperse the clay particles. The cells were then placed in a pre-heated oven and hot-rolled at 65° C. for 16 hours. After the thermal treatment, each cell was cooled to room temperature. The treated fluids were then poured onto two standard sieves: 10 mesh (2 mm) and 35 mesh (0.5 mm). The residual clays inside the ageing cells were recovered by washing with a KCl solution (42.75 g/1). The sieved fluids were recovered for further testing.

The sieves were transferred in a bath containing tap water and quickly but gently submerged in order to rinse both the sieve and the clays. The recovered clays were then placed in a pre-weighted capsule and oven-dried to constant weight at 105° C. After drying, the clays were cooled in a desiccator and weighted. The % recovery of the clays for each mud was calculated with the following formula:

$$\% Recovery = {W}_{R} \times 100 / {W}_{I}$$

where:
W_{R}=Weight in grams of the recovered clay;
W_{I}=Initial weight in grams of the clay (as dry matter).

The dry matter content of the clay was determined by drying at 105° C. until constant weight.

The results of the recovery test are reported in Table 2: the higher the % recovery, the higher the performance of the wellbore stabilizer.

TABLE 2

| | | | Car- | Rice | Bees- | Can- | |
|---|---|---|---|---|---|---|---|
| | Blank | H05B* | nauba | Bran | wax | delilla | Sumac |
| Melting | — | — | 84.5 | 79.2 | 57.3 | 57.2 | 37.4 |
| Point | | | | | | | |
| % Rec. | 27.3 | 68.9 | 77.5 | 85.5 | 79.4 | 89.3 | 83.2 |
| (2-4 mm) | | | | | | | |
| % Rec. | 14.1 | 0.9 | 1.2 | 2.3 | 1.2 | 0.9 | 0.8 |
| (0.5-2 mm) | | | | | | | |
| Total % | 41.4 | 69.8 | 78.7 | 87.8 | 80.6 | 90.2 | 84.0 |
| Recov. | | | | | | | |

*Comparative

All the wax particles show a sharp increase in the recovery of the clays in comparison with the blank. In particular, the low values of fraction 0.5-2 mm demonstrate that the waxes prevent the clay from disintegration.

Comparing the results of the waxes with each other, it is evident that the natural wax particles have a higher increase over the blank compared to the Polyethylene Wax particles.

### Rheology and Fluid Loss Test

The fluids remaining after the disintegration test of the dispersive clay particles were used to evaluate the effects of natural wax on fluid rheology and fluid loss. For this purpose, the pH of the fluids was brought to about 9 with a 20% by weight NaOH solution.

The Fluid Loss Test was performed using a standard HPHT filtration equipment, using ceramic filter discs (12 μm) and collecting the filtrate after 30 min at 65° C. and 500 psi of delta pressure. The filtrate volume (FLV) is expressed in milliliters. The lower the filtrate, the higher the performance of the natural wax emulsion. The rheology measurements were performed at 25° C. according to API Standard (API Recommended Practice 131/ISO 10416:2008) using the OFITE Model 800 viscometer. The rheology data and the filtrate volume results are reported in Table 3.

TABLE 3

| | | | Rice | | | |
|---|---|---|---|---|---|---|
| | Blank | Carnauba | Bran | Beeswax | Candelilla | Sumac |
| 600 RPM | 42 | 50 | 56 | 49 | 93 | 67 |
| 300 RPM | 29 | 35 | 39 | 34 | 61 | 46 |
| 200 RPM | 23 | 28 | 31 | 28 | 48 | 37 |
| 100 RPM | 16 | 20 | 22 | 20 | 34 | 27 |
| 6 RPM | 5 | 6 | 8 | 7 | 10 | 9 |
| 3 RPM | 3 | 5 | 6 | 6 | 8 | 7 |
| GEL 10″* | 5 | 7 | 8 | 9 | 9 | 10 |
| GEL 10′* | 5 | 9 | 9 | 9 | 12 | 11 |
| AV** | 21 | 25 | 28 | 24.5 | 46.5 | 33.5 |
| PV** | 13 | 15 | 17 | 15 | 32 | 21 |
| YP* | 16 | 20 | 22 | 19 | 29 | 25 |
| FLV | 34 | 16 | 28 | 24 | 24 | 25 |

*in lb/100 ft² (1 lb/100 ft² = 0.479 Pa)
**in mPa*s

The results obtained in both tests show that Carnauba Wax is to be preferred among the other natural waxes because it has no impact on the fluid rheology and significantly reduces the fluid loss, while having a good stabilization property. Candelilla wax, which shows the best result in the Dispersive Clay Particle Disintegration Test, increases the fluid viscosity, especially at high shear, and has inferior fluid loss reduction property. The results of the rheology and fluid loss tests show that the protective barrier created by Carnauba wax is resistant to the temperatures and pressures, the can be encountered when drilling a wellbore.

What is claimed is:

1. A method of reducing the soil disintegration when drilling a wellbore for the production of oil or gas in unstable clayey soils comprising the following steps: (a) providing a water-based drilling fluid comprising 0.5 to 6.0 g/100 ml of microparticles, having a median particle size comprised between 0.020 and 10 □m, of a natural wax with a melting point comprised between 3° and 95° C.; (b) drilling the borehole in the presence of the water-based drilling fluid that contains said wax microparticles, thereby reducing the soil disintegration.

2. The method of claim 1, wherein the water-based drilling fluid comprises from 1.0 to 5.0 g/100 ml of said natural wax microparticles.

3. The method of claim 1, wherein the median particle size of said natural wax microparticles is comprised between 0.040 and 1.0 □m.

4. The method of claim 1, wherein said natural wax microparticles are selected in the group consisting of Carnauba Wax, Candelilla Wax, Beeswax, Rice Bran Wax, Sumac Wax, Jojoba Wax microparticles and mixtures thereof.

5. The method of claim 4, wherein said natural wax microparticles are Carnauba Wax microparticles.

6. The method of claim 1, wherein said natural wax microparticles are added to the water-based drilling fluid in the form of an aqueous emulsion.

7. Use of microparticles having a median particle size comprised between 0.020 and 10 □m of a natural wax with a melting point comprised between 3° and 95° C., in a water-based drilling fluid, for reducing the soil disintegration when drilling a wellbore for the production of oil or gas in unstable clayey soils in the presence of the water-based drilling fluid, wherein the water-based drilling fluid comprises from 0.5 to 6.0 g/100 ml of the microparticles.

8. Use of microparticles according to claim 7 wherein the water-based drilling fluid comprises from 1.0 to 5.0 g/100 ml of the microparticles.

9. Use of microparticles according to claim 7, wherein the median particle size of the microparticles is comprised between 0.040 and 1.0 □m.

10. Use of microparticles according to claim 7, wherein the microparticles are selected in the group consisting of Carnauba Wax, Candelilla Wax, Beeswax, Rice Bran Wax, Sumac Wax, Jojoba Wax microparticles and mixtures thereof.

11. Use of microparticles according to claim 10, wherein the microparticles are Carnauba Wax microparticles.

12. Use of microparticles according to claim 7, wherein the microparticles are added to the water-based drilling fluid in the form of an aqueous emulsion.

13. A water-based drilling fluid comprising 0.5 to 6.0 g/100 ml of microparticles having a median particle size comprised between 0.020 and 10 □m of a natural wax with a melting point comprised between 3° and 95° C.

14. Water-based drilling fluid according to claim 13 comprising from 1.0 to 5.0 g/100 ml of said natural wax microparticles.

15. Water-based drilling fluid according to claim 13, wherein the median particle size of said natural wax microparticles is comprised between 0.040 and 1.0 □m.

16. Water-based drilling fluid according to claim 13, wherein said natural wax microparticles are selected in the group consisting of Carnauba Wax, Candelilla Wax, Beeswax, Rice Bran Wax, Sumac Wax, Jojoba Wax microparticles and mixtures thereof.

17. Water-based drilling fluid according to claim 16, wherein said natural wax microparticles are Carnauba Wax microparticles.
